(19) United States
(12) Patent Application Publication
(10) Pub. No.: US 2010/0074984 A1
(43) Pub. Date: Mar. 25, 2010

(54) BLOWING MOLD

(76) Inventor: Leonardo Arcuri Neto, Sao Paulo (BR)

Correspondence Address: OSTROLENK FABER GERB & SOFFEN, 1180 AVENUE OF THE AMERICAS, NEW YORK, NY, 100368403, US

(21) Appl. No.: 12/515,617

(22) PCT Filed: Jul. 19, 2007
(86) PCT No.: PCT/BR2007/000185

§ 371 Date: May 20, 2009

(30) Foreign Application Priority Data
Nov. 21, 2006 (BR) PI 0604823-4
Apr. 11, 2007 (BR) C1 0604823-4

(51) Int. Cl. B29C 49/04

(52) U.S. Cl. 425/532

(57) ABSTRACT

To allow to increase the production capacity of conventional blow molding machines by using the space available within it, more specifically by using the available space in the direction of the nominal path of opening and closing the original distribution line for mold cavities of the blowing machine and through which it will be possible to increase the assembly in distribution lines for mold cavities, which will be located in parallel, in the direction of the nominal path of opening and closing the molds and, for that, the blowing mold as disclosed herewith incorporates an embodiment allowing joint displacement of equal side and intermediary halves composing mold cavities, so to neutralize the force tending to promote the opening of the halves of contiguous mold cavities, which is generated by the pneumatic pressure as introduced, by means of blowing pins, inside parisons which are located at the mold cavities, with no need to change the required compression force to keep closed the mold-bearing tables of the blowing machine.

### FIELD OF APPLICATION

The present description refers to a development introduced in a “BLOWING MOLD” concerning the technical field of plastic molding and, more specifically, to the technical field of blow molding of plastic to produce packages in general, aiming to provide significant improvement in the production capacity of blow molding machines as currently existing the market, not however changing their original building characteristics, and also not offering any change in usual standards of the blow molding process.

### SUMMARY OF THE INVENTION

The “BLOWING MOLD” as proposed herein manages to reach its object to provide improvement in the production capacity of conventional blow molding machines from using space available within it, more specifically to use the space available in the direction of the original nominal path to open and close the distribution line of mold cavities of conventional blowing machines.

The improvement in productivity of conventional blowing machines is reached by the possibility of improvement in assembly of mold cavity lines, which will be located in parallel among them, in the direction of original nominal path to open and close the molds, and for that purpose the “BLOWING MOLD” as proposed herein incorporates constructivity to allow the joint displacement of same side and intermediary halves composing the mold cavity, so to neutralize the force tending to promote the opening of the halves of contiguous mold cavities, which is generated by the introduced pneumatic pressure through blowing pins inside parisons located within mold cavities, with no need to change the compression force which is exerted against mold-bearing tables in the blowing machines.

### SUMMARY OF THE RELATED ART

As known, the operation of a blowing machine is essentially based on the extrusion of a thermoplastic material formed from granulated raw material, to obtain a pliable product forming a kind of hose, also named parison, which is heated at a temperature to allow its expansion by means of pneumatic pressure to be supplied, through a blowing pin, to within the parison, after it has been involved by the halves composing the mold cavity, making it adapt to the contours of excavated surfaces within said halves composing the mold cavity where, due to the refrigeration system as included in said halves, will solidify to thus define the final shape of the blown part which production is desired.

Among implementations as introduced with time in the basic concept of operation of blowing machines, some are related to the improvement in the number of mold cavities and consequently the number of parison-forming heads and the number of blowing pins, aiming to improve production capacity by operation cycle of the machine, including the opening of molds and spacing apart the halves composing mold cavities; mold-bearing table displacement until the position of parison-forming heads; involvement of parisons by spaced apart halves composing the mold cavity; closing of molds and getting closer the halves composing the mold cavity around parisons; mold-bearing table displacement to the position in which blowing pins will be received inside parisons as located in mold cavities; production of blowing inside parisons as located within mold cavities; conformation of parisons against excavated surfaces of the halves of mold cavities; cooling the formed part inside the mold cavities; trimming formed parts inside the mold cavities; and the final extraction of molded parts.

Other implementations relate to positioning mold-bearing tables and consequently positioning blowing pin lines, which work opposed and simultaneously, over one single parison forming head, so that, while mold cavities of a mold-bearing table are involving parisons just formed by the head, the other mold-bearing table is already receiving, inside parisons as located within mold cavities, the blowing from the corresponding blowing pin line, so that within the time interval for the mold bearing table which just received parisons within mold cavities may end its cycle, the opposed mold-bearing table already proceeded to extract molded parts and is already in position to receive new parisons which are being formed by the head, practically doubling the productive capacity of the blowing machine.

The movement of mold-bearing tables regarding parison forming heads has also been the target of technical solutions aiming to improve the productivity of blowing machines, so that in some equipments a few mold-bearing tables were provided to be displaced lengthwise, while in others mold-bearing tables describe an inverted arch, so to allow e.g. to improve the speed of parison supply.

Implementations applied to the extruders were also supplied, so to optimize the capacity or variety of the produced thermoplastic material, with the purpose e.g. to form multiple-layer parisons, formed by equal or different materials, for use in special packages, which use may be determined by product and/or user protection issues, or for aesthetical reasons and external finishing of the package.

Other implementations also preview the control of parison forming heads, to allow their supply in pulsed form, with the purpose e.g. to create new effects in packages.

In the search for better yielding of blowing machines, a few double molds have been created, also called twin molds, where parison is located inside a mold cavity having higher and lower excavated surfaces; i.e. with excavated surfaces located in a mirror, but having the same face; this solution, although improving productivity, presents a few inconveniences, since packages in the upper region of the mold cavity are not as heavy as the packages in the lower region of the mold cavity, due to expansion of the parison, which is provided by gravity, due to its own weight, requiring the use of parison programmers to minimize this effect, besides also presenting another great inconvenience, which is not to allow, in the sequence of operation, to calibrate the throat with the set of blowing pin and cutting band, thus requiring later work to be performed, with lower quality, besides limiting the kind of package which may be produced by this kind of mold.

No matter how diverse projects are contemplated, blowing machines currently existing in the market, also known as extrusion-blowing machines, are essentially different due to the movements of their constituent components, among which we highlight movements provided by horizontal rotating tables; by vertical rotating tables; by plain tables with pendular, sliding or straight movement, which are positioned according to carthesian axis coordinates (X, Y and Z); by extruders, continuous or accumulated, blowing from below, blowing from above and blowing from the side by means of needles, and also by those operating with more than one extruder (coextrusion); in all of them, however, the basic concept of the blowing molding process is always maintained; i.e. the plastic material is inserted into the funnel feeding the extruder which changes the state of the granulated plastic material by increasing its temperature from solid to pasty, and sends it to a simple or multiple head, always provided in line, and distributing material for its transformation into parisons, which will be positioned to be involved by the halves forming mold cavities which, after closed, are displaced to receive, inside parisons located in the mold cavities, pins or blowing artifacts introducing pneumatic pressure to inside parisons, expanding them against excavated surfaces of the halves of mold cavities, where refrigeration means are provided, therefore causing solidification of expanded parisons, assuming the form of the mold, being them trimmed to take out excesses so that, subsequently, halves of mold cavities may be opened to extract produced parts.

However, no matter the proposed solutions, productivity limit for a blowing machine is directly linked to the ability of movement of the mold-bearing table and the creation of inertia forces, which tend to limit the size of molds; i.e. there are physical limits for the displacement of the mold-bearing table over the size of the machine, consequently resulting in solutions which also tend to be limited.

It can be seen, from the basic functional principle of a conventional blowing machine, that various improvements were introduced, thus resulting in technical advances providing better automation stage and productive capacity and therefore we now have in the market today machines of various kinds and capacities, formed by various kinds of devices, such as extruders; parison-forming heads; blowing pins; molds; mold-bearing tables; trimmers; stampers; means to extract produced parts and others, which have synchronized movements which are regulated by means of advanced control systems to guarantee process quality and yielding.

However, despite the large diversity of engineering resources and the up-to-date state of the art in the field, all known blow molding machines maintain at least one common feature among them; i.e. the direction of opening and closing of the mold over the position of parisons; i.e. no matter the number and location of mold cavities, these and their respective parisons are always sequentially distributed in one single perpendicular line to the movement of opening and closing the mold.

### Basics of the Invention

On the other hand, a blowing machine is normally designed to produce parts with various sizes and shapes, and therefore has a mold-bearing table with nominal path of opening and closing with large dimensional tolerance, and, when smaller parts are being produced, such nominal path of opening and closing of the mold-bearing table is relatively small, thus generating idle nominal path capacity, while in the production of smaller parts, this nominal path of opening and closing the mold-bearing table may be near or on the limit of its dimensional tolerance.

Therefore, when parts with dimensions near or on the lower limit of their nominal path capacity to open and close the mold-bearing table are being produced, the required dimension to open and close the mold is relatively small and therefore there is space in the direction of opening and closing the mold which is not used in conventional blowing machines when small parts are being produced.

Therefore, the main purpose of the “BLOWING MOLD” as presented herewith is to propose the occupation of the idle nominal path capacity to the direction of opening and closing the mold, basically consisting in the inclusion of a higher number of distribution lines of mold cavities, which will be located in parallel, in the direction of opening and closing the mold.

Another object of the “BLOWING MOLD” as presented herewith is to provide for a quantity of distribution lines of mold cavities to be determined as a function of the thickness or diameter of the parts to be produced; the path of opening and closing of the original mold of the blowing machine; the thickness of mold cavity walls in the direction of the path of opening and closing the mold, and the quantity and extension of mold opening and closing paths as originated by the introduction of a larger number of mold cavity lines.

Another object of the “BLOWING MOLD” as presented herewith is to obtain significant increase in the production capacity of the blowing mold, keeping its original nominal standards, particularly those limiting the addition of mold cavity distribution lines by quantity of parison forming heads, which are determined by the size of their mold-bearing table in the direction of the nominal path of opening and closing the mold, and the required force to close mold cavities, which should be at least slight higher than applied while blowing, which is approximately 8 kgf/cm².

Another object of the “BLOWING MOLD” as presented herewith is to provide a central parison forming head, provided with two or more parison forming lines, located in parallel in the direction of opening and closing the mold, and two or more blowing pin lines, also located in parallel in the direction of opening and closing distribution lines of the mold cavities, preferably two pairs of blowing lines, wherein each pair is located on each side of the parison forming lines of the head.

Another object of the “BLOWING MOLD” as proposed is to provide, at each parison forming line of the head and in association to each line of blowing pins, two or more parallel lines for distribution of mold cavities, so that, at each full cycle of the blowing machine, two or more parts may be produced, no matter the implementations as applied for each mold.

Another object of the “BLOWING MOLD” as presented herewith is to enable the inclusion of distribution lines of mold cavities; parison forming lines and blowing pin lines, determined as a function of the size of the blowing machine and the dimension of the nominal path of opening and closing distribution lines in the mold cavities, in combination with the size of the package to be produced, as measured in the direction of opening and closing the mold.

Another object of the “BLOWING MOLD” as presented herewith is to enable to assemble two or more distribution lines of mold cavities in any type of blowing machine, preferably in a blowing machine with plain table with multiple mold cavities, wherein, due to its large dimensional tolerance in the direction of opening and closing the mold, the force of closing mold cavities as required to neutralize pressure, generated by the pneumatic pressure produced inside parisons located in mold cavities, is not changed.

Another object of the “BLOWING MOLD” as proposed herewith is to enable to simultaneously close side and intermediary halves of the mold cavities in the form of bellows, so to null forces generated by pneumatic pressure as produced inside parisons located in intermediary mold cavities, thus just requiring to keep closing of side mold cavities.

The “BLOWING MOLD” as presented herewith is basically and essentially comprised by two or more distribution lines of mold cavities which are located in parallel in the direction of opening and closing the mold, being each mold cavity formed by two side halves of mold cavities and by two or more intermediary halves of mold cavities, being said side halves of mold cavities rigidly joined to the same intermediary halves of mold cavities, so that, when the side halves of mold cavities are closed, intermediary halves of mold cavities are simultaneously closed.

Like this embodiment, the added distribution lines for mold cavities will be located as if reproduced in parallel and sequentially in the same direction of opening and closing the mold of the original blowing machine.

Therefore, the original number of mold cavities may be multiplied by the number of times as allowed by the dimension of the nominal opening and closing path for the mold, and the size of the part to be blown, as measured in the direction of mold opening and closing, not changing original dimensional features of the blowing machine; furthermore, means of production of the closing force of mold cavities, intended to support pneumatic pressure as exerted inside parisons located in mold cavities, do not present limitations to the present solution, since, by the concept of action and reaction of forces, just the required force to lock side distribution lines of mold cavities will be necessary, since intermediary distribution lines for mold cavities, as they are parallel and designed over said distribution side lines for mold cavities, not adding its sections on the perpendicular direction to the direction of mold opening and closing; i.e. in the direction where production means of the forces to open and close intermediary lines of mold cavities act, will null each other, thus not verifying the need of any change in usual process conditions.

Therefore, with the application of the “BLOWING MOLD” as proposed, we obtain significant savings in production cost since, with the same blowing machine, we can reach significant yielding increase by just using appropriate heads to form and position parisons and appropriately sized molds for this purpose, which opening and closing system may be performed, depending on the type of machine and product to be manufactured, by different means, such as mechanical; hydraulic; pneumatic; mixed with manual work; cursors, spacers; draggers; trammels; wedges and others, and said movements should always be synchronized, so that distribution lines of mold cavities are opened and closed simultaneously, which may be done by means of machine commands.

### BRIEF DESCRIPTION OF THE DRAWINGS

To better understand the “BLOWING MOLD” as proposed herewith, we make reference to the attached representative drawings, so that it can be fully reproduced by appropriate skills, allowing the full characterization of its functionality, being said drawings merely illustrative and may present variations, as long as they do not escape from the functional principle as proposed, wherein:

FIGS. 1 to 3—show side-cut schematic views of a mold-bearing table of the state of the art, which show, in the parallel plan to the direction of mold opening and closing, an example of the operation cycle to produce blown molded parts, where we can see, on FIG. 1, the mold opened with its halves spaced apart and the parison located between them, having on FIG. 2 the mold closed with its halves involving the parison and, on FIG. 3, the mold again open with spaced apart halves, showing the blown molded part;

FIG. 4—shows a perspective view of a mold-bearing table of the state of the art, provided with one single distribution line of mold cavities, in opening position;

FIG. 5—shows a perspective view of a mold-bearing table of the state of the art, provided with one single distribution line of mold cavities, in closing position;

FIGS. 6 to 8—show side-cut schematic views of a mold-bearing table, which show, in the parallel plan to the direction of mold opening and closing as proposed herewith, an example of the operation cycle to produce blown molded parts, where we can see, on FIG. 6, the molds opened with their halves spaced apart and the parisons located between them, having on FIG. 7 the molds closed with their halves involving the parisons and, on FIG. 8, the molds again open with spaced apart halves, showing the blown molded parts;

FIG. 9—shows a perspective view of a mold-bearing table of the invention, provided, as an example, with two distribution lines of mold cavities, in opening position;

FIG. 10—shows a perspective view of a mold-bearing table of the invention, provided, as an example, with two distribution lines of mold cavities, in closing position;

FIG. 11—shows a front perspective schematic view of a mold-bearing table of an alternative embodiment of the invention, provided, as an example, with two distribution lines of mold cavities, in opening position;

FIG. 12—shows a back perspective schematic view of a mold-bearing table of an alternative embodiment of the invention, provided, as an example, with two distribution lines of mold cavities, in closing position;

FIG. 13—shows a front schematic view of a mold-bearing table of an alternative embodiment of the invention, provided, as an example, with two distribution lines of mold cavities, in opening position;

FIG. 14—shows a front schematic view of a mold-bearing table of an alternative embodiment of the invention, provided, as an example, with two distribution lines of mold cavities, in closing position;

FIG. 15—shows a back schematic view of a mold-bearing table of an alternative embodiment of the invention, provided, as an example, with two distribution lines of mold cavities, in opening position;

FIG. 16—shows a back schematic view of a mold-bearing table of an alternative embodiment of the invention, provided, as an example, with two distribution lines of mold cavities, in closing position;

FIG. 17—shows an upper schematic view of a mold-bearing table of an alternative embodiment of the invention, provided, as an example, with two distribution lines of mold cavities, in opening position;

FIG. 18—shows an upper schematic view of a mold-bearing table of an alternative embodiment of the invention, provided, as an example, with two distribution lines of mold cavities, in closing position;

FIG. 19—shows a side schematic view of a mold-bearing table of an alternative embodiment of the invention, provided, as an example, with two distribution lines of mold cavities;

FIG. 20—shows a view in the cut sense A-A of FIG. 19; and

FIG. 21—shows a view in the cut sense B-B of FIG. 19.

### PREFERRED EMBODIMENT OF THE INVENTION

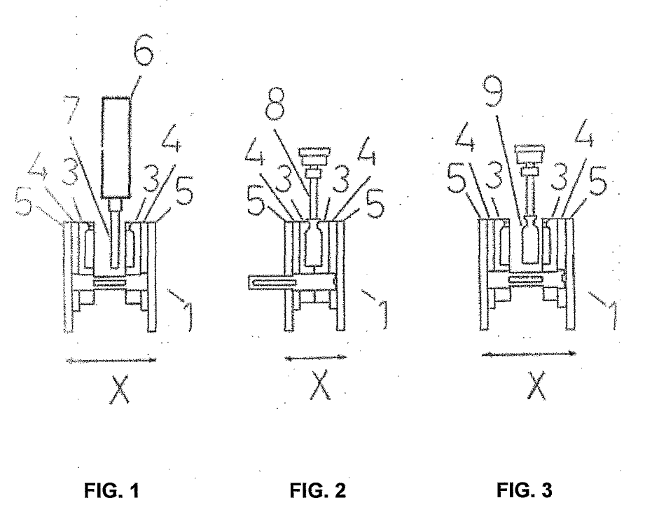

According to what is shown by FIGS. 1 to 5, the blowing mold (1) as currently used in conventional blowing machines is essentially provided with one single distribution line (Z) for mold cavities (2), which are provided side by side, crosswise to the direction (X) of mold opening and closing, thus determining the production of parts, by operation cycle of the blowing machine, which quantity is equal to the number of cavities provided in the distribution line for mold cavities, being said mold formed by two halves (3) composing the mold cavity and on which confronting surfaces corresponding halves are excavated to form the surface relief of the package to be produced, having around said mold cavities flat support surfaces (4) for said halves composing mold cavities, which, on their end, will be supported by sides (5) composing the mold-bearing table, wherein said mold thus constituted works in cooperation with a head (6) responsible to form parisons (7) of thermoplastic material, which quantity is also equivalent to the number of cavities as provided in the distribution line for mold cavities.

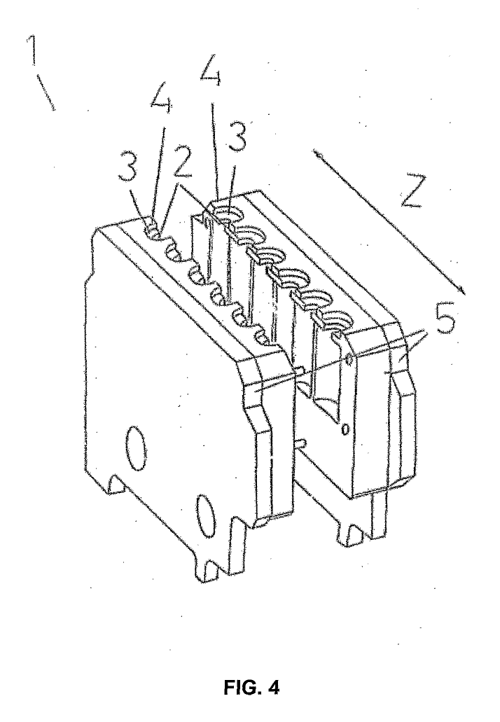

At the start of the operation cycle of the blowing machine, the halves composing the mold cavity are spaced apart by the mobile parts of the mold-bearing table for its opening, after which the mold-bearing table is displaced until a position where the halves composing the mold cavity, still in its opening position, start to involve the just formed parison by the parison forming head, as shown by FIG. 1, and halves composing the mold cavity subsequently get closer by means of the mobile parts of the mold-bearing table for its closing, thus closing the parison inside the mold cavity, so to subsequently enable to mold-bearing table to be displaced to where it will receive, inside the parison as located in the mold cavity, the blowing pin (8), as shown by FIG. 2, which injects pneumatic pressure inside the parison located within the mold cavity, and the halves composing the mold cavity are kept closed by supplying appropriate force to support the pressure generated by the blowing pin, which will cause the expansion of the parison, adhering to the excavated surfaces on the halves composing the mold cavity and, as a consequence of cooling such surfaces, it will solidify, taking the final package form, with exceeding thermoplastic material being subsequently trimmed so that, afterwards, the mobile parts of the mold-bearing table are again moved so to space apart halves composing mold cavity, to dismantle the blown part (9), as shown by FIG. 3, with the movements of the mobile parts of the mold-bearing table and the halves composing the mold cavity may be performed by hydraulic, pneumatic, mechanical means or these technologies mixed and are synhronized with other components of the blowing equipment, by control means of the equipment operation logics.

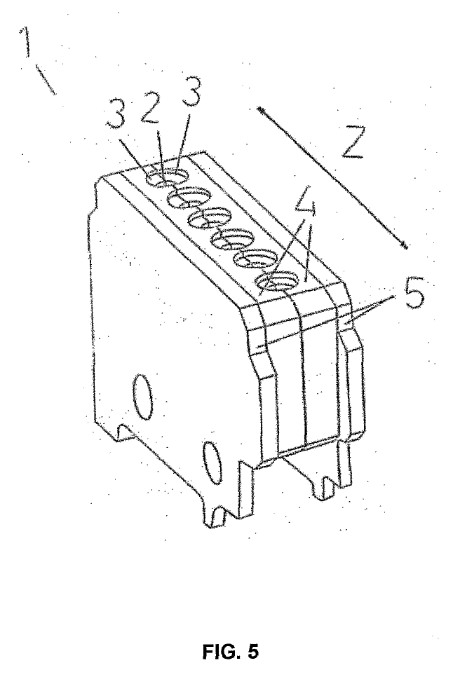

FIGS. 4 and 5 show a mold-bearing table as used by conventional blowing machines in opening and closing position, respectively, provided with one single distribution line for mold cavities.

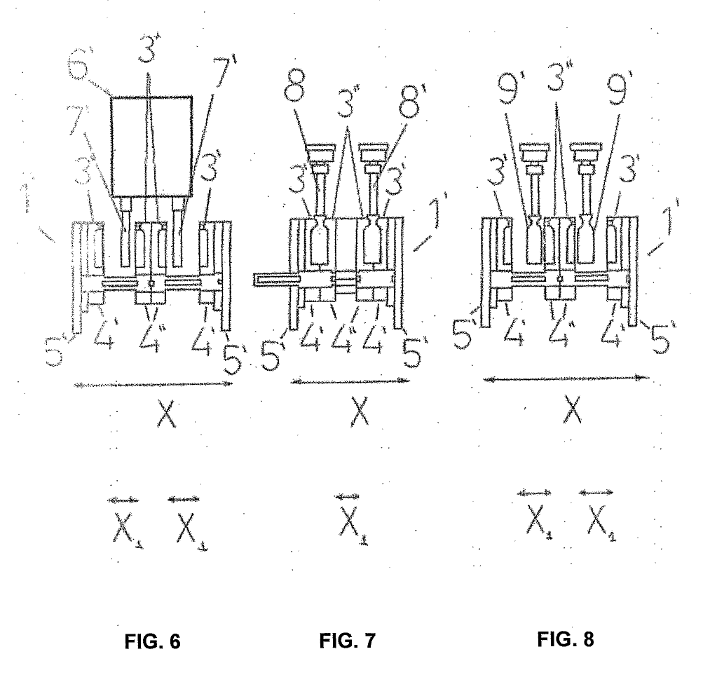

According to what is shown by FIGS. 6 to 8, the blowing mold (1′) as proposed by the teachings of the invention, provided, as an example, with two distribution lines (Z) and (Z₁) for mold cavities (2′), located in parallel, in the direction (X) of opening and closing molds, being said molds therefore formed by side halves (3′) of mold cavities and by two intermediary halves (3″) of mold cavities and on which confronting surfaces corresponding halves are excavated to form the surface relief of the package to be produced, being said equal, side and intermediary halves rigidly joined to each other by means of wedges (3a) or any other appropriate means for this purpose, so to allow said side and intermediary halves to jointly close, one against the other, forming mold cavities, located side by side, crosswise to the direction of opening and closing molds, being distribution lines for mold cavities located in parallel, taking the original linear length of the mold-bearing table of the blowing machine and extending to the direction (X₁) of the original nominal path of mold opening and closing, wherein, around said side and intermediary halves of the molds of distribution lines for mold cavities, side (4′) and intermediary (4″) flat surfaces to support said halves of molds are provided, being said side flat surfaces, on their hand, supported by sides (5′) composing the mold-bearing table, and the molds thus constituted will work in association with the head (6′) responsible to form two parison lines (7′) and will have mold cavities of the distribution lines for mold cavities preferentially located within regular spaces from each other, having the cavities of one distribution line for mold cavities preferrably located crosswise to the cavities of the other distribution line for mold cavities.

Therefore, at the start of the operation cycle of the blowing machine, side and intermediary halves of mold cavities are spaced apart by the mobile parts of the mold-bearing table for its opening, after which the mold-bearing table is displaced until a position where side and intermediary halves composing mold cavities, still in their opening position, start to involve the just formed parisons by the parison forming head, as shown by FIG. 6, and side and intermediary halves composing the mold cavities subsequently get closer by means of the mobile parts of the mold-bearing table for their closing, thus closing the parisons inside the mold cavities, so to subsequently enable to mold-bearing table to be displaced to where it will receive, inside the parisons as located in the mold cavities, the blowing pins (8), as shown by FIG. 7, which inject pneumatic pressure inside the parisons located within the mold cavities, and the side and intermediary halves composing the mold cavities are kept closed by supplying appropriate force to support the pressure generated by the blowing pins, which will cause the expansion of the parisons, adhering to the excavated surfaces on the side and intermediary halves composing mold cavities and, as a consequence of cooling such surfaces, they will solidify, taking the final package form, with exceeding thermoplastic material being subsequently trimmed so that, afterwards, the mobile parts of the mold-bearing table are again moved so to space apart side and intermediary halves composing mold cavities, to dismantle the blown parts (9′), as shown by FIG. 8, with the movements of the mobile parts of the mold-bearing table and the side and intermediary halves composing mold cavities may be performed by hydraulic, pneumatic, mechanical means or these technologies mixed and are synchronized with other components of the blowing equipment, by control means of the equipment operation logics.

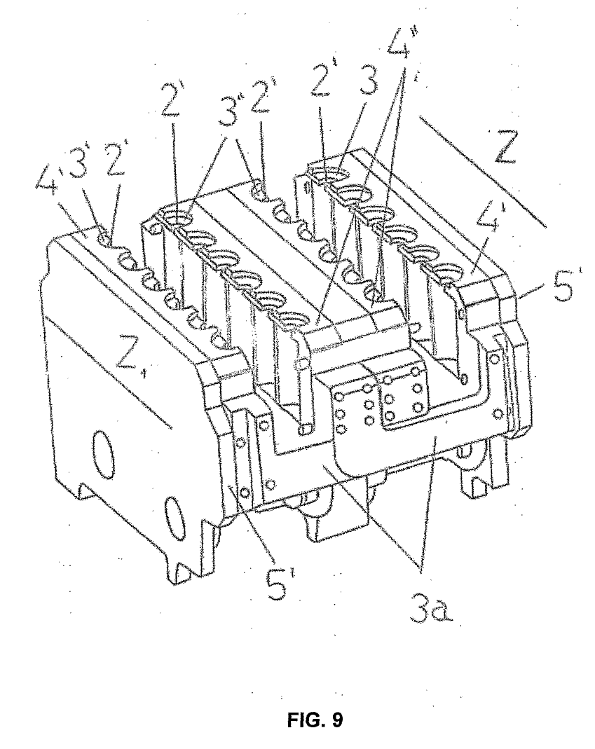

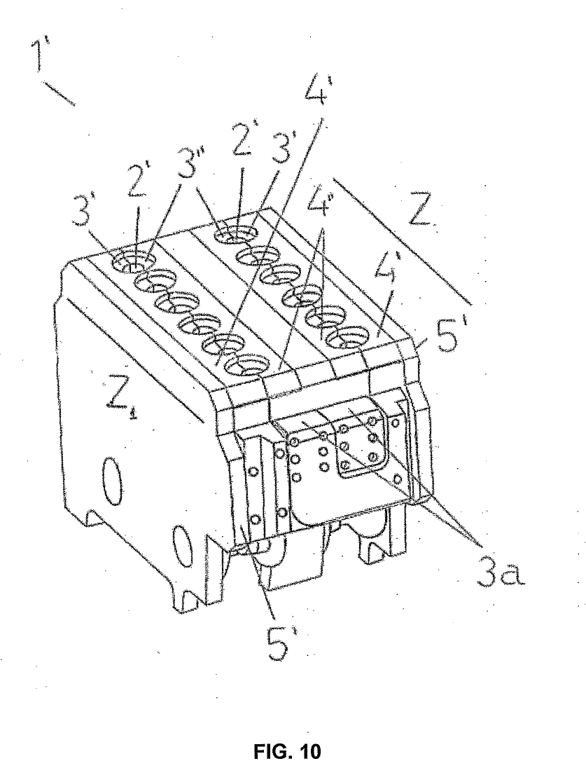

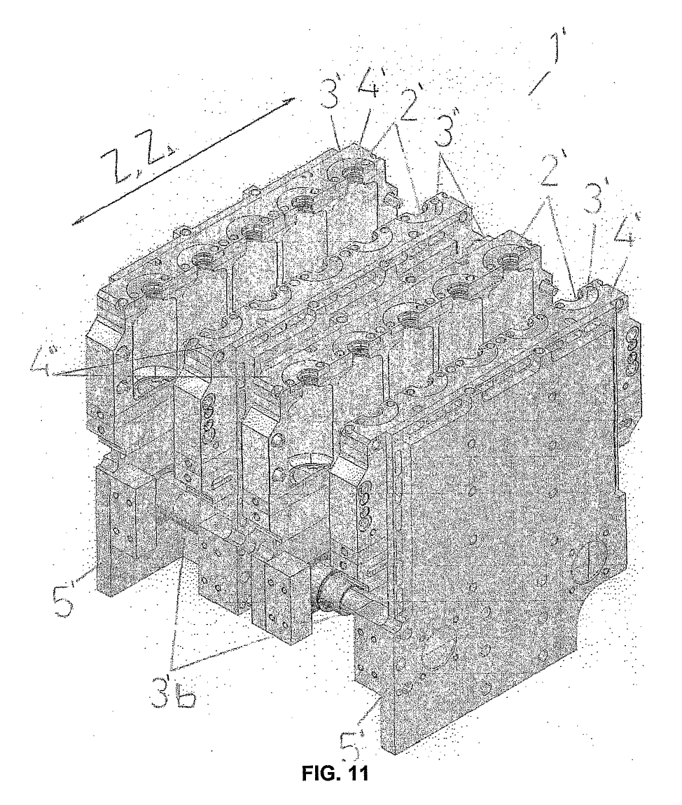

FIGS. 9 and 10 show a mold-bearing table as used by conventional blowing machines incorporating the present invention, in opening and closing position, respectively, provided, as an example, with two distribution lines for mold cavities.

### Alternative Embodiment of the Invention

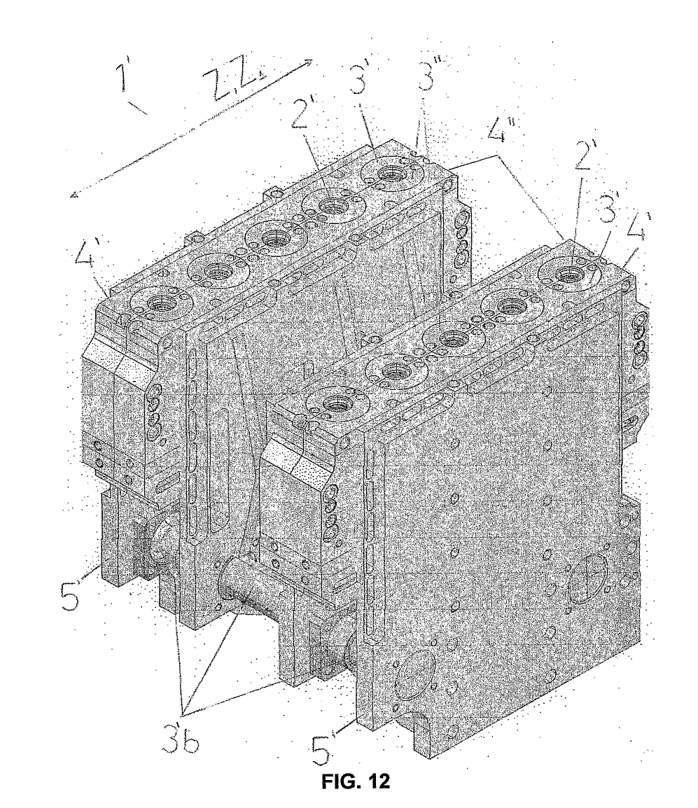

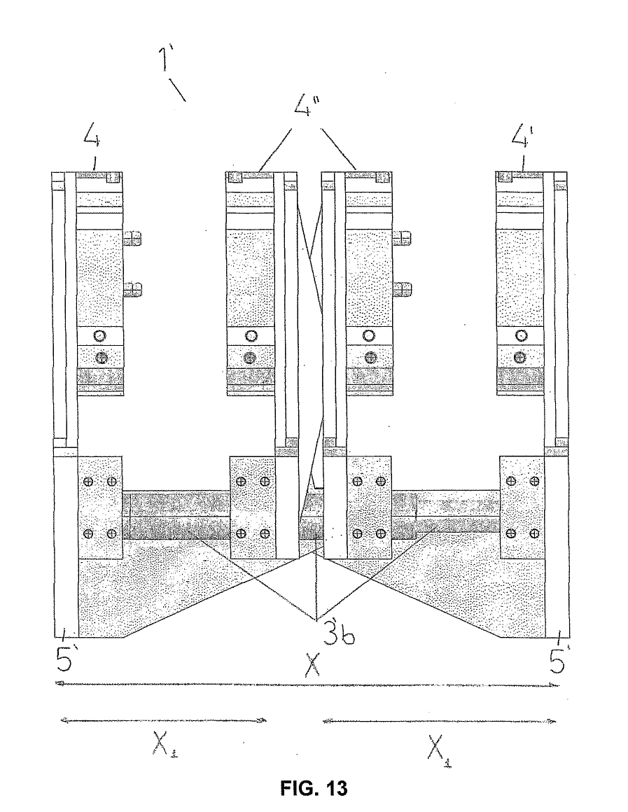

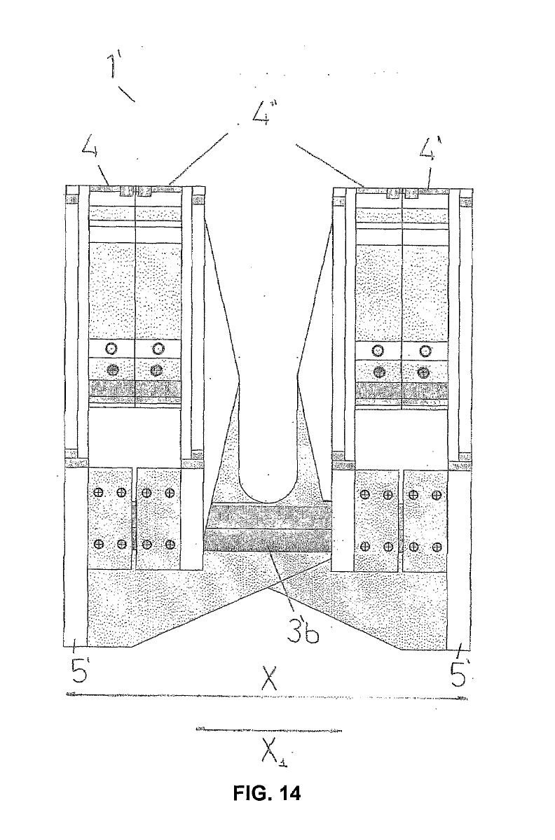

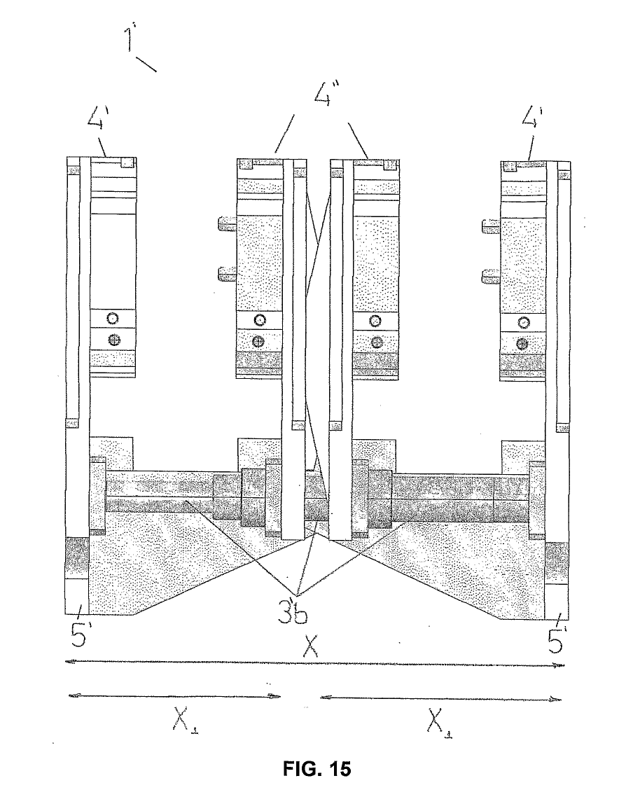

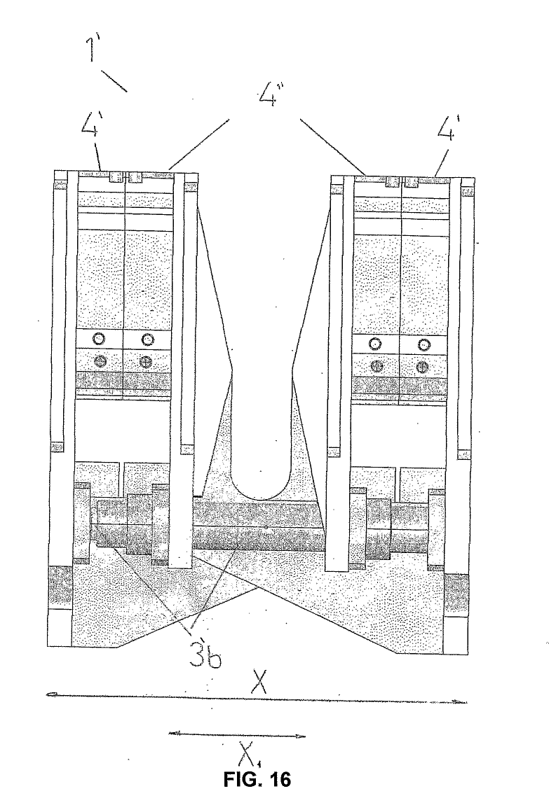

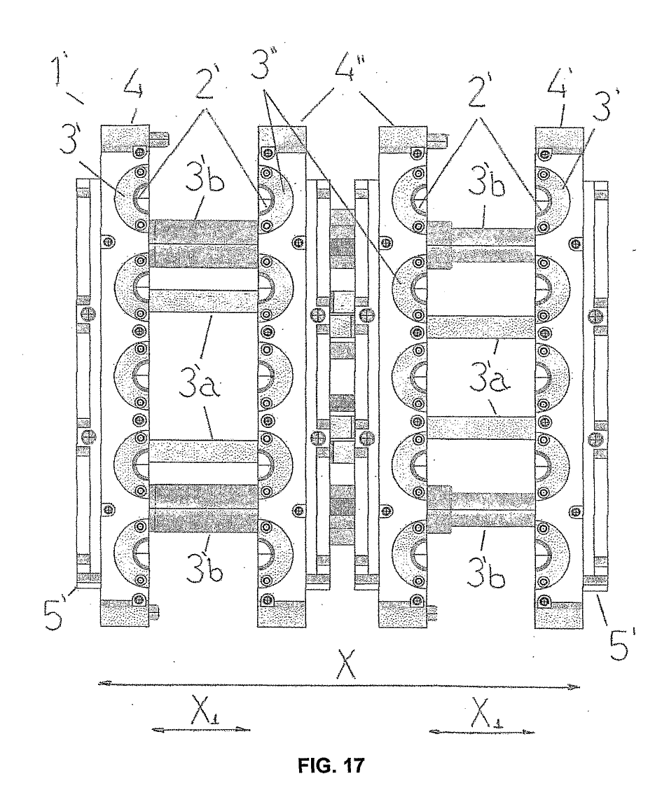

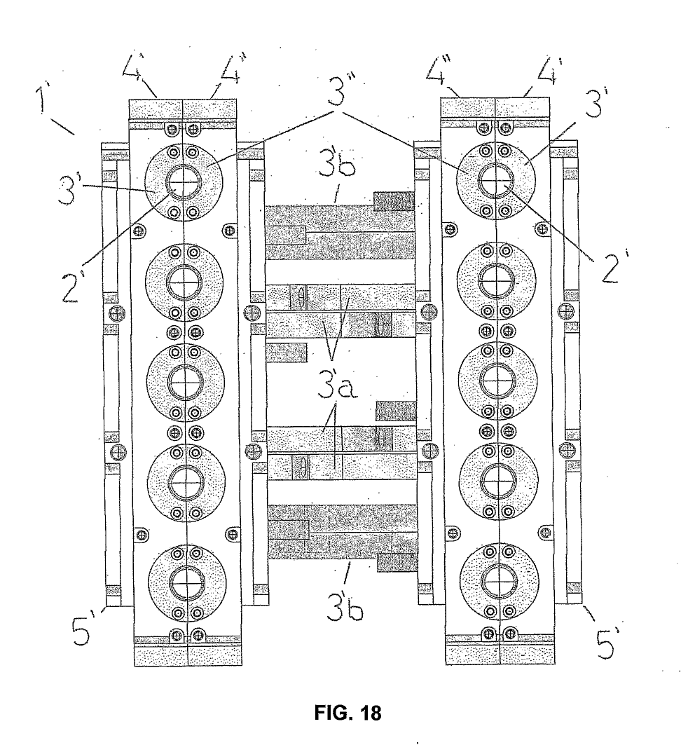

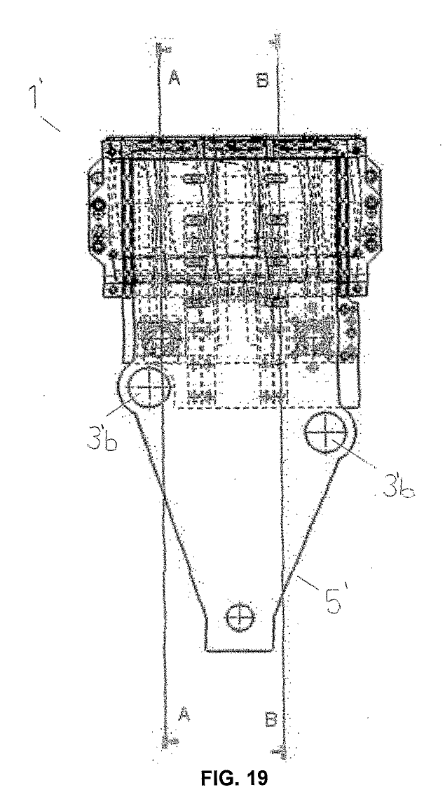

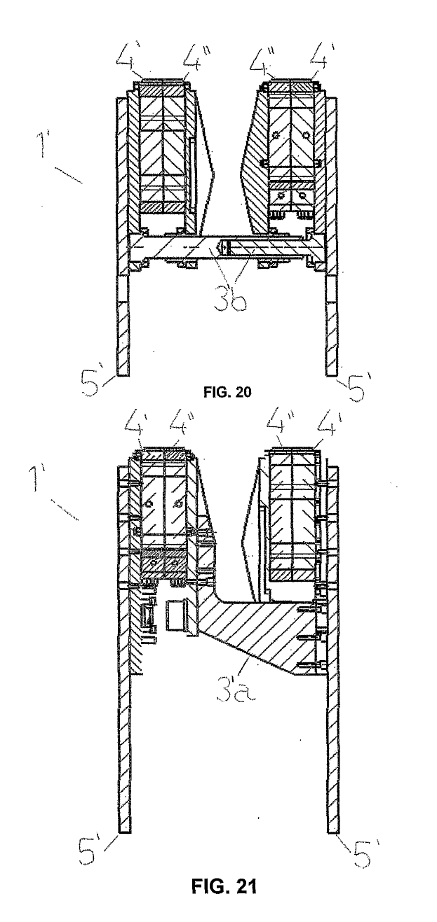

FIGS. 11 to 21 show an alternative embodiment of the invention, wherein the blowing mold (1′) is provided, as an example, with two distribution lines (Z) and (Z₁) for mold cavities (2′), located in parallel, in the direction (X) of opening and closing molds, being said molds therefore formed by side halves (3′) of mold cavities and by two intermediary halves (3″) of mold cavities and on which confronting surfaces corresponding halves are excavated to form the surface relief of the package to be produced, being said equal, side and intermediary halves rigidly joined to each other by means of displacement guides (3′a) located in parallel at the lower region of the mold-bearing table, which are located crosswise to the direction of opening and closing molds, which work jointly with telescopic tubes (3′b), also located in parallel at the lower region of the mold-bearing table, outside said displacement guides, which are also located crosswise to the direction of opening and closing molds, to allow said side and intermediary halves to jointly close, one against the other, forming mold cavities, located side by side, crosswise to the direction of opening and closing molds, being distribution lines for mold cavities located in parallel, taking the original linear length of the mold-bearing table of the blowing machine and extending to the direction (X₁) of the original nominal path of mold opening and closing, wherein, around said side and intermediary halves of the molds of distribution lines for mold cavities, side (4′) and intermediary (4″) flat surfaces to support said halves of molds are provided, being said side flat surfaces, on their hand, supported by sides (5′) composing the mold-bearing table, and the molds as therefore constituted will work in association with the head (not shown) responsible to form two parison lines (not shown) and will have mold cavities of the distribution lines for mold cavities preferentially located within regular spaces from each other, having the cavities of one distribution line of mold cavities preferably located crosswise to the cavities of the other distribution line of mold cavities.

In both cases, the number of distribution lines for mold cavities will be substantially defined as a function of the dimension of the original nominal path in the direction of mold opening and closing; the longer dimension of the part to be blown, as measured in the direction of the original nominal path for opening and closing the mold; the quantity and extension of nominal paths for opening and closing as originated by adding distribution lines for mold cavities and the thickness of the walls of the side and intermediary halves of mold cavities in the nominal path direction for opening and closing the mold, being this last standard limited to meet operational requirements for blow molding, so that a larger quantity of pairs of side and intermediary halves of mold cavities, forming distribution lines for mold cavities, may be located within the original space of the mold-bearing table, as extended in the direction of the nominal path of mold opening and closing.

Therefore, as the measurements of the nominal path in the direction of opening and closing a conventional mold as applied to a blowing machine are projected so that, when the parts to be blown with dimensions (d) at the lower nominal limit or near, generate idle path segments in the direction of opening and closing the mold, which may use, when produced, parts with dimensions (D) at the higher nominal limit or near it, also in the direction of the path of opening and closing the mold and, since conventional force generating means to close the molds are able to generate closing force which is appropriate to the longer crosswise section to the direction of the path of opening and closing the mold and to the higher nominal force of molding blow, it is an object of the “BLOW MOLDING” as disclosed herewith to take such idle segment in the path in the direction of opening and closing the mold, when parts to be blown have dimensions (dₘ) varying between d≦dₘ<D in the direction of the path of opening and closing the mold and, for such, thickness of the walls of side and intermediary halves of the cavities of molds in the distribution lines for mold cavities and the dimensions of constituent elements of the mold-bearing table in the direction of the path of opening and closing the mold will be determined as a function of the longer dimension of the part to be blown, as measured in the direction of the path of opening and closing the mold; the original nominal direction of the nominal path of opening and closing the mold, and the quantity and extension of the opening and closing paths of the pairs of side and intermediary halves of the distribution lines for mold cavities to be added to the blowing machine, which will determine the limit number of distribution lines for mold cavities; i.e. all dimensions of the side and intermediary halves of mold cavities, as located in the direction of the path of opening and closing the mold, will be crucial to make better use of the space of the blowing machine in the direction of the original path of opening and closing, aiming to create the higher number of mold cavity lines within said space, not compromising the operation of the mold-bearing table set and molds.

Furthermore, since original acting means for the mold-bearing table are appropriate to provide adequate closing force to the original mold, which is a function, among others, of the confronting area of the halves composing the mold cavity and the required closing force to support blowing, the “BLOWING MOLD” as proposed herewith, although having a series of distribution lines for mold cavities and corresponding side and intermediary halves of mold cavities, present confrontation areas between them which are exactly the same as the conventional mold, since distribution lines for mold cavities as added are parallel and made within the limits of the area confronting side and intermediary halves of the molds, which is exactly the same as the confrontation area of the original mold of the blowing machine, thus resulting in the same system of action and reaction forces of the conventional mold and, therefore, mold acting means as disclosed herewith may be the same as used in the original mold of the blowing machine, however presenting multiplied yielding over said conventional mold, due to the introduction of multiple distribution lines for mold cavities, using the same acting means of the mold-bearing table of conventional molds, thus resulting in significant advantage of the present mold over conventional ones.

1- A blowing mold comprising taking the idle nominal path capacity in the direction of opening and closing the mold in conventional blowing machines, which is made by the inclusion of distribution lines for mold cavities to be parallelly located in the direction of opening and closing of molds and to be located in quantity to be determined as a function of the thickness or diameter of the parts to be produced; the path of opening and closing the original mold of the blowing machine; the thickness of walls of mold cavities in the direction of the path of opening and closing molds and the quantity and extension of the paths of opening and closing molds, originated from the added mold cavity lines, so to keep unchanged original nominal standards of the blowing machine, particularly those limiting the addition of distribution lines for mold cavities by quantity of parison-forming heads and which are determined by the size of the mold-bearing table in the direction of the nominal path of opening and closing molds and the required force to close mold cavities, which should be at least slightly larger than applied by the pneumatic pressure of blowing.

2- The blowing mold of claim 1, comprising providing a central parison forming head, provided with two or more parison forming lines, located in parallel in the direction of opening and closing the mold, and two or more blowing pin lines, also located in parallel in the direction of opening and closing distribution lines for mold cavities.

3- The blowing mold of claim 1, comprising preferably providing two pairs of blowing lines, being each pair located on each side with parison forming lines from the head, being also provided, in each parison forming line of the head and in association with each blowing pin line, with at least two parallel lines for mold cavity distribution, so that, at each full cycle of the blowing machine, at least two parts may be produced, no matter the implementations applied for each mold.

4- The blowing mold of claim 1, comprising the inclusion of distribution lines for mold cavities; parison forming lines and blowing pin lines, being determined as a function of the size of the blowing machine and the dimension of the nominal path of opening and closing distribution lines in the mold cavities, in combination with the size of the package to be produced, as measured in the direction of opening and closing the mold.

5- The blowing mold of claim 1, comprising the fact that its assemble may include more than two distribution lines for mold cavities and may be applied to any type of blowing machine.

6- The blowing mold of claim 1, comprising the inclusion of distribution lines of cavities being preferably made in a blowing machine with flat table and multiple mold cavities, wherein, due to its large dimensional tolerance in the direction of opening and closing the molds, the force of closing mold cavities, as required to neutralize the pressure generated by the pneumatic pressure as produced inside parisons located in mold cavities, is not changed.

7- The blowing mold of claim 1, comprising the simultaneous closing of side and intermediary halves of mold cavities, in the form of bellows, nulling forces generated by pneumatic pressure as produced inside parisons located in intermediary lines for mold cavities, just requiring to the production of maintenance force to close the side lines of mold cavities.

8- The blowing mold of claim 1, comprising the distribution lines of mold cavities, located in parallel, in the direction of opening and closing the molds, having side halves of mold cavities rigidly joined to the intermediary halves equal to mold cavities, so that, when side halves of mold cavities are closed, intermediary halves of mold cavities are simultaneously closed.

9- The blowing mold of claim 1, comprising the added distribution lines for mold cavities being located as if reproduced in parallel and sequentially in the same direction of opening and closing mold of the original blowing machine.

10- The blowing mold of claim 1, comprising the fact that the quantity of distribution lines for mold cavities to be added may vary according to the dimension of the original nominal path of opening and closing the blowing machine and the longer dimension of the part to be blown, as measured in the direction of opening and closing the mold.

11- The blowing mold of claim 1, comprising the intermediary distribution lines of mold cavities being parallel and projected over side distribution lines for mold cavities, not adding their sections in the crosswise direction to the direction of opening and closing molds, nulling the force as generated by the pneumatic pressure exerted inside the parisons as located in mold cavities of intermediary distribution lines.

12- The blowing mold of claim 1, comprising the fact that equal side and intermediary halves of the distribution lines for mold cavities being rigidly joined together, allowing them to be jointly closed together.

13- The blowing mold of claim 12, comprising the equal side and intermediary halves of the distribution lines of mold cavities being joined together by means of wedges or any other appropriate means for this purpose, located in parallel, in the lower region of the mold-bearing table, which are located crosswise to the direction of opening and closing molds.

14- The blowing mold of claim 12, comprising the equal side and intermediary halves of the distribution lines of mold cavities being joined together by means of displacement guides, located in parallel, in the lower region of the mold-bearing table, which are located crosswise to the direction of opening and closing molds.

15- The blowing mold of claim 1, comprising each distribution line for mold cavities having its mold cavities preferably located, under regular spaces among them, having the cavities of one distribution line for mold cavities preferably located crosswise to the cavities of another distribution line for mold cavities.

16- The blowing mold of claim 1, comprising the quantity of distribution lines for mold cavities to be added in the direction of the nominal path of opening and closing molds being limited to meet the requirements of operation of the blow molding machine.

17- The blowing mold of claim 1, comprising the quantity of distribution lines for mold cavities to be added in the direction of opening and closing molds allowing to produce blown parts, which dimensions may vary between the lower and higher limit of the nominal path in the direction of opening and closing molds, as originally designed for the blowing machine or near them.

18- The blowing mold of claim 1, comprising the thickness of walls of side and intermediary halves of the mold cavities of distribution lines as added, and the measurements of the mold-bearing table components in the direction of the path of opening and closing the mold, being determined as a function of the longer dimension of the part to be blown, as measured in the direction of the path of opening and closing molds; original nominal path in the direction of the nominal path of opening and closing molds, and the quantity and extension of paths of opening and closing the side and intermediary halves of distribution lines for mold cavities as added.

19- The blowing mold of claim 1, comprising the distribution lines of mold cavities as added having limits of areas confronting side and intermediary halves of mold cavities exactly the same as the confrontation areas of the original mold of the blowing machine, thus allowing to use the same acting means as used to activate the original mold of the blowing machine.
